(19) United States
(12) Patent Application Publication
(10) Pub. No.: US 2017/0255910 A1
(43) Pub. Date: Sep. 7, 2017

(54) ONLINE TRANSACTION PROCESSING SYSTEM WITH ADAPTIVE ACQUIRER SELECTION

(71) Applicant: Amadeus S.A.S., Biot (FR)

(72) Inventors: Cedric Florimond, Vallauris (FR); Mathieu Le Marier, Geneva (CH)

(21) Appl. No.: 15/062,843

(22) Filed: Mar. 7, 2016

(51) Int. Cl. G06Q 20/10; G06Q 20/38

(52) U.S. Cl. CPC G06Q 20/102; G06Q 20/381

(57) ABSTRACT

Online transaction processing systems and methods for adaptively selecting an optimal acquirer system for an online transaction involving a merchant. At least one mass storage memory device stores a database that includes a set of records. Each of the records includes data that relates to one of a set of issuer systems. In response to receiving payment data that is associated with an online transaction involving the merchant and that relates to a particular one of the issuer systems, the data that relates to the particular issuer system is retrieved from the database. Thereafter, an optimal acquirer is selected for the online transaction from a set of acquirer systems that each have a relationship with the merchant based on the retrieved data.

### TECHNICAL FIELD

The present invention generally relates to online transaction processing systems and, more particularly, to systems and methods for adaptively selecting acquirer systems for online transactions.

### BACKGROUND

When a customer initiates an online transaction with a merchant for a good or service, the customer typically provides credit card information to the merchant over the Internet. Thereafter, to collect payment for the online transaction, the merchant communicates the customer's credit card to an acquiring bank contracted with the merchant. The acquiring bank then contacts the issuing bank of the customer's credit card and requests funds from the customer's account. Once the requested funds are received from the issuing bank, the acquiring bank provides the funds to the merchant.

Merchants often have relationships with multiple acquirer banks that may collect payment on the merchant's behalf. In this way, when the merchant receives payment information for an online transaction, the merchant selects one of its acquirer banks to collect the payment. In previous systems, the merchant has based this selection on the purchase point of sale (i.e., the location of the customer when initiating the online transaction). However, in the context of online credit card transactions, selecting an acquirer bank on this basis alone can result in added costs to the merchant in the form of increased banking fees. Moreover, it can result in increased processing complexity for the merchant, such as if the selected acquirer bank is in a jurisdiction having relatively cumbersome regulations. In either case, the online transaction becomes less than optimal for the merchant.

Accordingly, a need exists for improved online transaction processing systems and methods for adaptively selecting acquirer systems so as to optimize online transactions for a merchant.

### SUMMARY

In one embodiment, an online transaction processing system for adaptively selecting an optimal acquirer system for an online transaction involving a merchant includes at least one mass storage memory device. The mass storage memory device stores a database that includes a set of records, where each of the records includes data relating to one of a set of issuer systems. The online transaction processing system further includes one or more processors and a memory coupled to the processors. The memory includes instructions that upon execution by the processors causes the online transaction processing system to, in response to receiving payment data that is associated with an online transaction involving the merchant and that relates to a particular one of the issuer systems, retrieve, from the database, the data that relates to the particular issuer system. The instructions upon execution further cause the online transaction processing system to select an optimal acquirer system for the online transaction from a set of acquirer systems that each have a relationship with the merchant based on the data retrieved from the database.

In a further embodiment, a method for adaptively selecting an optimal acquirer system for an online transaction involving a merchant includes receiving, at one or more processors, payment data that is associated with an online transaction involving the merchant and that relates to a particular one of a set of issuer systems. The method also includes querying, by the one or more processors, a database based on the payment data. The database is stored on at least one mass storage memory device and includes a set of records, where each of the records includes data that relates to one of the issuer systems. The method further includes receiving, at the one or more processors and from the database, the data that relates to the particular issuer system, and selecting, by the one or more processors, an optimal acquirer system for the online transaction from a set of acquirer systems that each have a relationship with the merchant based on the data received from the database.

In another embodiment, a computer program product includes a non-transitory computer readable medium. Instructions are stored on the non-transitory computable readable medium and, upon execution by one or more processors, the instructions cause the one or more processors to receive payment data that is associated with an online transaction involving the merchant and that relates to a particular one of a set of issuer systems. The instructions upon execution also cause the one or more processors to query a database based on the payment data. The database is stored on at least one mass storage memory device and includes a set of records, where each of the records includes data that relates to one of the issuer systems. The instructions upon execution further cause the one or more processors to receive, from the database, the data that relates to the particular issuer system, and select an optimal acquirer system for the online transaction from a set of acquirer systems that each have a relationship with the merchant based on the data received from the database.

### BRIEF DESCRIPTION OF THE DRAWINGS

Embodiments of the present invention will be understood and appreciated more fully from the following detailed description taken in conjunction with the drawings.

FIG. 1 is a schematic view of an exemplary operating environment that includes a plurality of computer systems that may be involved in an online transaction.

FIG. 2 is a schematic view of an exemplary computer system of FIG. 1.

FIG. 3 is a schematic view of an exemplary processing architecture that may be utilized in an online transaction to adaptively select an acquirer system.

FIG. 4 is a flowchart of an exemplary process for adaptively selecting an acquirer system that may be performed by the processing architecture of FIG. 3.

### DETAILED DESCRIPTION

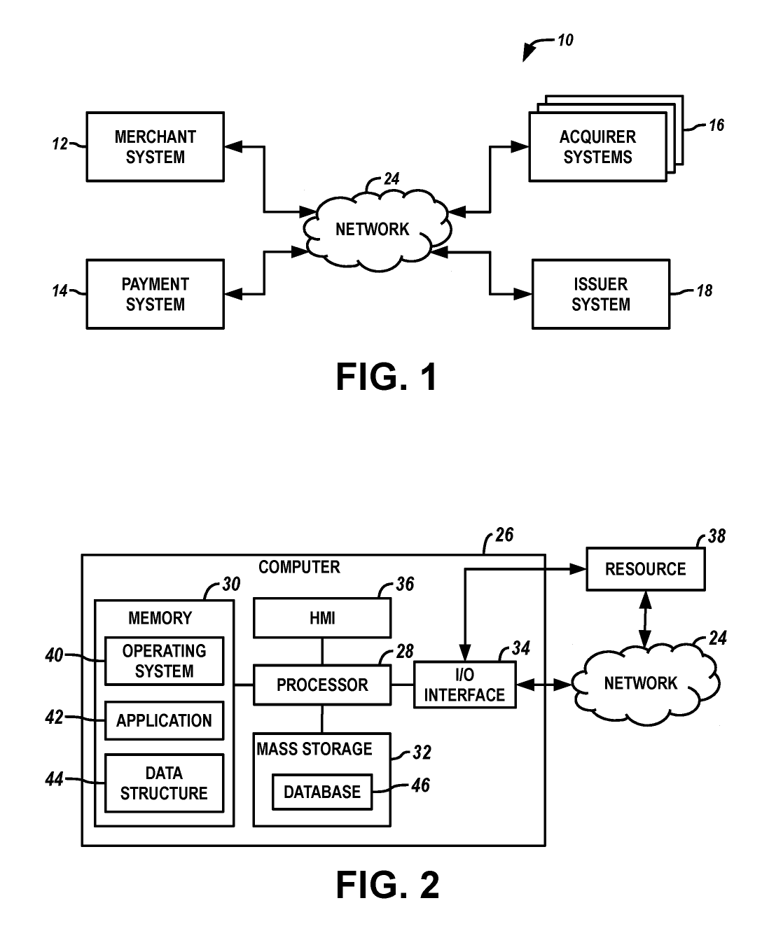

FIG. 1 illustrates an operating environment 10 that may include a merchant system 12, a payment system 14, two or more acquirer systems 16, and/or an issuer system 18. Each of these systems may communicate with one another through a network 24, such as the Internet. Furthermore, two or more of these systems may be integrated with one another.

The merchant system 12 may include any system configured to facilitate the business operations of a merchant, such as an airline, a hotel, a rail provider, a car rental agency, a travel agent, etc. For example, the merchant system 12 may include a front end system, such as a user interface in which customers may initiate online transactions with the merchant. In addition, the merchant system 12 may include a reservation system configured to generate and store a passenger name record (PNR) for each purchase or reservation made with the merchant. Each PNR may include information relating to the goods and/or services of a purchase or reservation (e.g., a reserved travel itinerary for one or more airline passengers), the fares or fees used to price the purchase or reservation, and/or payment data relating to the purchase or reservation (e.g., a customer's credit or debit card information). The merchant system 12 may further include a ticketing system configured to issue electronic tickets, and/or an inventory system configured to track the remaining inventory of the merchant (e.g., seats remaining on each flight segment). In the specific case of an airline merchant, the merchant system 12 may additionally include a departure control system (DCS) configured to manage the airline's airport operations on the day of travel (e.g., checking in passengers, printing boarding passes, etc.).

The merchant system 12 may also include a global distribution system (GDS) that is configured to enable customers and/or travel agents to search, purchase, and/or reserve the goods and/or services of multiple merchants via a single interface. Furthermore, the GDS may be configured to generate and store a reservation record for each purchase or reservation made through the GDS. A single one of these reservation records may include information relating to the goods and/or services of multiple merchants, regardless of the type of goods and/or services. In this way, when a purchase or reservation involves the goods and/or services of multiple merchants (e.g., a reservation that includes air service, rail service, car service, etc.), the GDS may generate a single reservation record for the entire purchase or reservation.

The payment system 14 may be configured to facilitate the payment-related operations of a merchant, such as collecting funds from a customer's bank account or receiving authorization that the customer has sufficient funds in his or her account. For example, when a customer initiates/participates in an online transaction with a merchant for goods and/or services, the customer may provide an electronic payment form to the merchant system 12 via the network 24. Thereafter, to collect payment for the online transaction, the merchant system 12 may communicate the electronic payment form to the payment system 14. The payment system 14 may then generate and send a capture request that includes the electronic payment form to one of the acquirer systems 16, such as a particular banking system. The acquirer systems 16 may be provided by one or more acquirers, such as one or more financial institutions. For example, one financial institution may provide two or more of the acquirer systems 16, or each acquirer system 16 may be provided by a different financial institution. Furthermore, each of the acquirer systems 16 may be located in a different geographic region (e.g., country), and each of the acquirer systems 16 and/or acquirers may have a distinct relationship with the merchant. For example, each of the acquirer systems 16 and/or acquirers may have an account for the merchant, and may be subject to a contractual agreement with the merchant to perform payment-related operations on the merchant's behalf.

After receiving the request, the acquirer system 16 may identify the issuer system 18 that issued the payment form to the customer, which may likewise be a banking system provided by a financial institution, and thereafter send a request to the issuer system 18 that funds be transferred from the customer's account. Once the funds have been received from the issuer system 18, the acquirer system 16 may provide the funds to the merchant, such as by placing the funds in the merchant's account.

A similar exchange may occur for an authorization operation, except that instead of sending a request to the issuer system 18 that funds be transferred from the customer's account, the acquirer system 16 may send a request for a confirmation that adequate funds for the online transaction are present in the customer's account. Once such a confirmation has been received from the issuer system 18, the acquirer system 16 may communicate the confirmation to the merchant. Thereafter, the merchant may release the goods and/or services of the online transaction to the customer.

When requesting performance of a payment-related operation, the payment system 14 may be configured to select one of the acquirer systems 16 such that the online transaction is optimized for the merchant. Specifically, prior to the implementation of electronic payment forms and the Internet, customers generally exchanged physical payment forms (e.g., cash, checks) with a merchant for the merchant's goods and/or services. Periodically, such as on a daily, weekly, or monthly basis, the physical payment forms collected by the merchant would be hand-carried to a local bank for deposit into the merchant's account. Hence, if a merchant had a physical presence in multiple regions, it was common for the merchant to have a contract or account with a bank local to each region for receiving the physical payments collected by the merchant in that region.

The emergence of electronic payment forms and the Internet, however, has enabled merchants to sell goods and/or services in any number of regions, and do so without having a physical presence in each one. Furthermore, because electronic payment forms can be transmitted across the world via the Internet almost instantaneously, it is no longer necessary for a merchant to utilize a bank in each region in which the merchant does business. Nevertheless, merchants who perform sales in multiple regions have continued to contract with acquirers in each region in which the merchant does business. Furthermore, these merchants have configured their systems such that, when a customer makes a purchase or reservation while located in a particular region, all of the payment-related operations for that purchase or reservation are automatically routed to the acquirer system 16 that is particular to that region. In other words, when requesting payment-related operations for online transactions, merchants have been using the purchase point of sale (i.e., the location of the purchaser when initiating/participating in the online transaction) as the sole factor to select the payment point of sale (i.e., the location of the acquirer system 16 to which a payment-related operation is routed). In many circumstances, however, basing the selection of an acquirer system 16 on the purchase point of sale alone results in a less than optimal transaction for the merchant.

More particularly, when an acquirer system 16 is selected to perform a payment-related operation on behalf of a merchant, the merchant is typically responsible for fees charged by the selected acquirer system 16 and fees charged by the customer's issuer system 18, both of which may vary depending on the location and/or home currency of the selected acquirer system 16 and the customer's issuer system 18. For example, if the selected acquirer system 16 and the issuer system 18 deal in different home currencies, then the merchant may be charged a currency conversion fee by either or both systems. These conversion fees may be charged to the merchant even if the merchant utilizes a third-party dynamic conversion currency (DCC) provider, which is a service that converts a foreign currency to a customer's home currency at the purchase point of sale. Accordingly, if a customer uses a credit for an online transaction while located in a region that deals in a currency differing from the home currency of the issuer system 18 for the credit card, then selecting an acquirer system 16 based on the purchase point of sale alone (i.e., the region dealing in the different currency) may result in unnecessary conversion fees being charged to the merchant.

As a further example, if the selected acquirer system 16 and the issuer system 18 are in different regions (e.g., countries), the merchant may be charged a border cross fee by either or both systems. In addition, depending on which region or regions the selected acquirer system 16 and/or the issuer system 18 is located, the merchant may also be responsible for ensuring compliance with increasingly complex government regulations, which in turn may increase the processing complexity and costs that are absorbed by the merchant. For example, some regional governments may include regulations that mandate the use of a particular bank for electronic transactions, which may only be adapted or approved to provide limited services, and which may charge higher transaction fees due to its monopoly in the region. Furthermore, some regional governments may impose additional transaction fees for the use of the banks in their regions, which further increases the costs to the merchant.

Accordingly, in order to optimize an online transaction for the merchant, the payment system 14 may be configured to base its selection of one of the acquirer systems 16 for a payment-related operation on more than just the purchase point of sale. In particular, the payment system 14 may be configured to select an acquirer system 16 based on the purchase details (e.g., the purchase currency, the type of goods and/or services purchased), information relating to the customer's issuer system 18, information relating to each of the acquirer systems 16, and/or government regulations in the regions in which the customer's issuer system 18 and the acquirer systems 16 are located. By taking one or more of these factors into account, with or without the purchase point of sale, the payment system 14 may reduce the transactional costs and processing complexity absorbed by the merchant for an online transaction, and thereby optimize the online transaction for the merchant as well.

Referring now to FIG. 2, the merchant system 12, the payment system 14, the acquirer systems 16, and/or the issuer system 18 may be implemented on one or more computer devices or systems, such as exemplary computer system 26. The computer system 26 may include a processor 28, a memory 30, a mass storage memory device 32, an input/output (I/O) interface 34, and a Human Machine Interface (HMI) 36. The computer system 26 may also be operatively coupled to one or more external resources 38 via the network 24 or I/O interface 34. External resources may include, but are not limited to, servers, databases, mass storage devices, peripheral devices, cloud-based network services, or any other suitable computer resource that may be used by the computer system 26.

The processor 28 may include one or more devices selected from microprocessors, micro-controllers, digital signal processors, microcomputers, central processing units, field programmable gate arrays, programmable logic devices, state machines, logic circuits, analog circuits, digital circuits, or any other devices that manipulate signals (analog or digital) based on operational instructions that are stored in the memory 30. The memory 30 may include a single memory device or a plurality of memory devices including, but not limited, to read-only memory (ROM), random access memory (RAM), volatile memory, non-volatile memory, static random access memory (SRAM), dynamic random access memory (DRAM), flash memory, cache memory, or any other device capable of storing information. The mass storage memory device 32 may include data storage devices such as a hard drive, optical drive, tape drive, non-volatile solid state device, or any other device capable of storing information.

The processor 28 may operate under the control of an operating system 40 that resides in the memory 30. The operating system 40 may manage computer resources so that computer program code embodied as one or more computer software applications, such as an application 42 residing in memory 30, may have instructions executed by the processor 28. In an alternative embodiment, the processor 28 may execute the application 42 directly, in which case the operating system 40 may be omitted. One or more data structures 44 may also reside in memory 30, and may be used by the processor 28, operating system 40, or application 42 to store or manipulate data.

The I/O interface 34 may provide a machine interface that operatively couples the processor 28 to other devices and systems, such as the network 24 or the one or more external resources 38. The application 42 may thereby work cooperatively with the network 24 or the external resources 38 by communicating via the I/O interface 34 to provide the various features, functions, applications, processes, or modules comprising embodiments of the invention. The application 42 may also have program code that is executed by the one or more external resources 38, or otherwise rely on functions or signals provided by other system or network components external to the computer system 26. Indeed, given the nearly endless hardware and software configurations possible, persons having ordinary skill in the art will understand that embodiments of the invention may include applications that are located externally to the computer system 26, distributed among multiple computers or other external resources 38, or provided by computing resources (hardware and software) that are provided as a service over the network 24, such as a cloud computing service.

The HMI 36 may be operatively coupled to the processor 28 of computer system 26 in a known manner to allow a user to interact directly with the computer system 26. The HMI 36 may include video or alphanumeric displays, a touch screen, a speaker, and any other suitable audio and visual indicators capable of providing data to the user. The HMI 36 may also include input devices and controls such as an alphanumeric keyboard, a pointing device, keypads, pushbuttons, control knobs, microphones, etc., capable of accepting commands or input from the user and transmitting the entered input to the processor 28.

A database 46 may reside on the mass storage memory device 32, and may be used to collect and organize data used by the various systems and modules described herein. The database 46 may include data and supporting data structures that store and organize the data. In particular, the database 46 may be arranged with any database organization or structure including, but not limited to, a relational database, a hierarchical database, a network database, or combinations thereof. A database management system in the form of a computer software application executing as instructions on the processor 28 may be used to access the information or data stored in records of the database 46 in response to a query, where a query may be dynamically determined and executed by the operating system 40, other applications 42, or one or more modules.

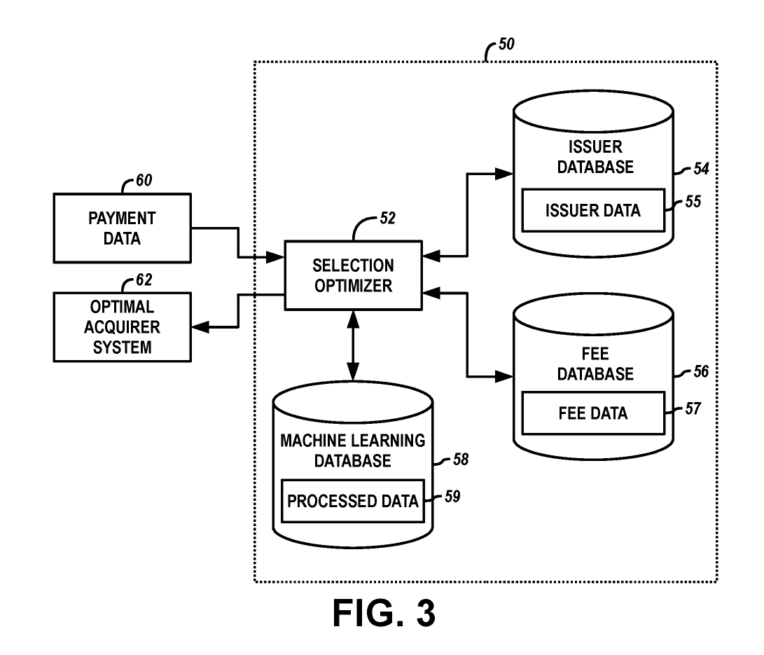

FIG. 3 illustrates a processing architecture 50 that may be implemented on the payment system 14 of operating environment 10. The processing architecture 50 may include a selection optimizer 52, an issuer database 54, a fee database 56, and/or a machine learning database 58. In operation, the processing architecture 50 may receive payment data 60, such as credit or debit card information, that was provided by a customer in relation to an online transaction with the merchant. Thereafter, the processing architecture 50 may be configured to select an optimal acquirer system 62 for the online transaction from the acquirer systems 16 having relationships with the merchant based on the payment data 60, issuer data 55 received from the issuer database 54, fee data 57 received from the fee database 56, and/or previously processed data 59 received from the machine learning database 58. Moreover, based on the received payment data 60 and the selected optimal acquirer system 62, the processing architecture 50 may be configured to populate or update the machine learning database 58, which in turn may be utilized by the processing architecture 50 to facilitate and/or speed up processing for subsequent online transactions. These and other operations of the processing architecture 50 are discussed in more detail below.

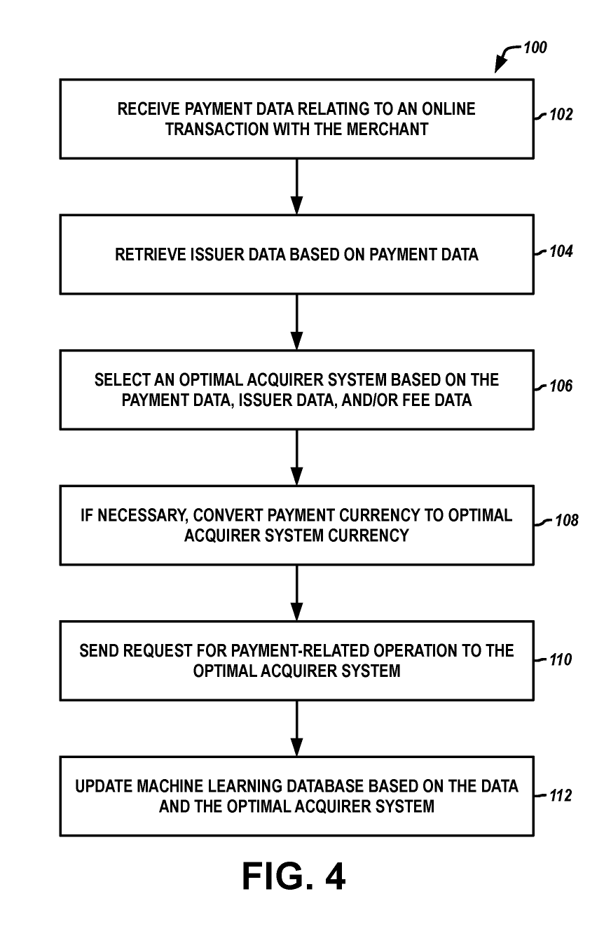

FIG. 4 illustrates a process 100 that may be performed by the processing architecture 50. In block 102, payment data 60 may be received, such as at the selection optimizer 52, that is associated with an online transaction between a customer and a merchant. More particularly, the payment data 60 may indicate the payment-related details of the online transaction, and/or may indicate information in a reservation record (e.g., a PNR) generated by the merchant system 12 for the online transaction. Information that may be indicated by the payment data 60 includes the electronic payment form provided by the customer for the transaction (e.g., the customer's credit or debit card information), the location in which the customer initiated or participated in the transaction (i.e., the purchase point of sale), the payment amount, the currency of the payment amount (which may differ from the home currency of the issuer system 18 for the electronic payment form), and/or the type of goods and/or services involved in the transaction (e.g., hotel, air, rail, etc.).

In block 104, issuer data 55 may be retrieved based on the payment data 60. More particularly, upon receiving the payment data 60, the selection optimizer 52 may be configured to query the issuer database 54 based thereon. The issuer database 54 may include a plurality of records, where each record includes issuer data 55 that relates to one of a set of potential issuer systems 18. The issuer data 55 of each record may be linked to information that may be included in the payment data 60 (referred to hereinafter as “potential payment data”). Accordingly, in response to receiving the query based on the payment data 60 from the selection optimizer 52, the issuer database 54 may be configured to return the issuer data 55 that is linked to information included in the received payment data 60.

The potential payment data of each record in the issuer database 54 may relate to an electronic payment form, such as a customer's credit or debit card, that may be included in the payment data 60. Specifically, when provided by a customer for an online transaction, an electronic payment form may include a unique identifier that is associated with the issuer system 18 that issued the electronic payment form to the customer. Accordingly, the potential payment data of each record in the issuer database 54 may include the unique identifier of an electronic payment form that may be provided by a customer, and the issuer data 55 of each record may include information about the issuer system 18 that is associated with the record's unique identifier. For example, the issuer data 55 may include the country of the issuer system 18, the home currency of the issuer system 18, and/or the type of payment form (e.g., credit card or debit card) issued by the issuer system 18 in connection with the unique identifier. In other words, a single issuer system 18 may be associated with multiple unique identifiers, each unique identifier being for a different type of payment form that is issued by the issuer system 18. Thus, when the selection optimizer 52 receives payment data 60 that includes a customer's electronic payment form, the selection optimizer 52 may be configured to query the issuer database 54 for information about the issuer system 18 that issued the electronic payment form to the customer.

In one exemplary embodiment, the records of the issuer database 54 may form a Bank Identification Number (BIN) table. Credit and debit cards typically include a BIN, which may be the first sequence of digits (e.g., six digits) of the credit or debit card number, that may be utilized to identify the issuer system 18 for the card and/or the type of card (e.g., debit or credit). Accordingly, the potential payment data of each record in the issuer database 54 may include a BIN, and the issuer data 55 of each record may include information about the issuer system 18 that is associated with the record's BIN. In this way, in response to receiving payment data 60 that includes a customer's credit or debit card data, the selection optimizer 52 may be configured to extract the BIN from the payment data 60, and thereafter query the BIN table of the issuer database 54 for information about the issuer system 18 associated with that BIN.

In block 106, an optimal acquirer system 62 may be selected for the online transaction from the acquirer systems 16 based on the payment data 60, the issuer data 55 retrieved from the issuer database 54, and/or fee data 57 retrieved from the fee database 56. More particularly, after the issuer data 55 is received from the issuer database 54, the selection optimizer 52 may be configured to query the fee database 56 for fee data 57, which may indicate the different merchant fees that would result from each of the acquirer systems 16 being selected for the online transaction. The selection optimizer 52 may thus be configured to utilize the fee data 57 of the fee database 56 to determine which acquirer system 16 will optimize the transaction for the merchant.

In some embodiments, the fee database 56 may include a plurality of records, with each record being associated with a different one of the acquirer systems 16. More particularly, each record may include fee data 57 that identifies one or more fees associated with one of the acquirer systems 16 in relation to performing a payment-related operation on the merchant's behalf. For example, each of the acquirer systems 16 may charge a service fee for performing a payment-related operation on the merchant's behalf, which may differ depending on the government regulations to which the acquirer system 16 is subject and/or the individual contract between the merchant and the provider of the acquirer system 16. Accordingly, the fee data 57 of each record may indicate the service fee charged by the acquirer system 16 associated with the record.

The fee data 57 of each record may also indicate the different merchant fees that would result from selecting a particular acquirer system 16 based on the payment data 60 and/or the issuer data 55 that was retrieved from the issuer database 54. For example, if an acquirer system 16 needs to cross a regional border to perform a payment-related operation with an issuer system 18, then the merchant may be charged a cross border fee by either or both systems. Moreover, if the acquirer system 16 and the issuer system 18 deal in different currencies, then the merchant may be charged a currency conversion fee by either or both systems. In addition, depending on the contractual agreements existing between the provider of an acquirer system 16 and the provider of the issuer system 18, the type of electronic payment form in the payment data 60 (e.g., credit or debit), and/or the payment form's association (e.g., VISA, MASTERCARD, AMERICAN EXPRESS, etc.), the merchant may be charged additional transaction fees (e.g., interchange fees, association fees) that are paid to the provider of the issuer system 18 and/or the payment form's association in exchange for processing the payment-related operation. Accordingly, the fee data 57 of each record may also indicate each of the above-described fees for one of the acquirer systems 16.

Thus, based on the payment data 60, the issuer data 55 retrieved from the issuer database 54, and/or the fee data 57 of each record stored in the fee database 56, the selection optimizer 52 may be configured to determine an optimal acquirer system 62 for the online transaction such that the online transaction is optimized for the merchant. More particularly, the selection optimizer 52 may be configured to utilize all or some of the above data to determine one or more transactional costs associated with each of the acquirer systems 16 for the current online transaction. In this way, the selection optimizer 52 is able to determine which of the acquirer systems 16 is associated with the lowest transaction costs, and select the acquirer system 16 associated with the lowest transactional costs as the optimal acquirer system 62. Consequently, the fees charged to the merchant will be minimized for the online transaction.

Once the optimal acquirer system 62 has been selected, in block 108, the payment amount for the online transaction, which may be included in the payment data 60, may be converted, if necessary, to the home currency for the optimal acquirer system 62. More particularly, the currency of the payment amount, which may likewise be included in the payment data 60, may differ from the home currency of the optimal acquirer system 62. Such a difference may result from the customer initiating or participating in an online transaction in a geographic region that differs from the geographic region of the issuer system 18 for the customer's payment form, where each of the geographic regions deal in different currencies. In this case, the currency used in the online transaction may be of the former geographic region, and to avoid currency conversion fees, the optimal acquirer system 62 may be selected such that its home currency is the same as the home currency of the latter geographic region and the customer's issuer system 18. Similarly, to avoid cross border fees and/or currency conversion fees, the optimal acquirer system 62 may be selected such that it is located in the same geographic region as the customer's issuer system 18.

Accordingly, the selection optimizer 52 may be configured to convert the payment amount from the payment currency used in the online transaction to the home currency of the optimal acquirer system 62, such as by using a third-party provider of conversion rates. In this way, the selection optimizer 52 is able to provide dynamic currency conversion without utilizing a DCC provider. Thereafter, in block 110, a request for a payment-related operation relating to the online transaction (e.g., a capture request, an authorization request), which may include the converted payment amount, may be transmitted to the optimal acquirer system 62 for processing.

In block 112, the machine learning database 58 may be updated based on the payment data 60 and the optimal acquirer system 62. More particularly, the selection optimizer 52 may include a machine learning mechanism that is configured to generate and store records in the machine learning database 58, with each record including previously processed data 59. The previously processed data 59 of each record may include one or more details of previous payment data 60 received by the selection optimizer 52 for a previous online transaction, and may be linked within the record to the previous optimal acquirer system 62 that was ultimately selected based on the previous payment data 60. In this way, in response to receiving additional payment data 60 associated with a subsequent online transaction, the selection optimizer 52 may be configured to speed up the selection of an optimal acquirer system 62 by querying the machine learning database 58 for a record that includes previously processed data 59 matching the additional payment data 60. If such previously processed data 59 is available, then the selection optimizer 52 may be configured to select the optimal acquirer system 62 that is linked to the matching previously processed data 59 as the optimal acquirer system 62 for the subsequent online transaction, which enables the selection optimizer 52 to bypass the other querying steps and provide a faster result. Moreover, if for any reason the payment data 60 received for a subsequent transaction is deficient such that the selection optimizer 52 is unable to successfully query the issuer database 54 based thereon, the selection optimizer 52 may be configured to query the machine learning database 58 for a record including previously processed data 59 that is similar to the deficient payment data 60. Thereafter, the selection optimizer 52 may be configured to select the optimal acquirer system 62 that is linked to the similar previously processed data 59 as the optimal acquirer system 62 for the subsequent transaction.

In general, the routines executed to implement the embodiments of the invention, whether implemented as part of an operating system or a specific application, component, program, object, module or sequence of instructions, or even a subset thereof, may be referred to herein as “computer program code,” or simply “program code.” Program code typically comprises computer readable instructions that are resident at various times in various memory and storage devices in a computer and that, when read and executed by one or more processors in a computer, cause that computer to perform the operations necessary to execute operations and/or elements embodying the various aspects of the embodiments of the invention. Computer readable program instructions for carrying out operations of the embodiments of the invention may be, for example, assembly language or either source code or object code written in any combination of one or more programming languages.

Various program code described herein may be identified based upon the application within that it is implemented in specific embodiments of the invention. However, it should be appreciated that any particular program nomenclature that follows is used merely for convenience, and thus the invention should not be limited to use solely in any specific application identified and/or implied by such nomenclature. Furthermore, given the generally endless number of manners in which computer programs may be organized into routines, procedures, methods, modules, objects, and the like, as well as the various manners in which program functionality may be allocated among various software layers that are resident within a typical computer (e.g., operating systems, libraries, API's, applications, applets, etc.), it should be appreciated that the embodiments of the invention are not limited to the specific organization and allocation of program functionality described herein.

The program code embodied in any of the applications/modules described herein is capable of being individually or collectively distributed as a program product in a variety of different forms. In particular, the program code may be distributed using a computer readable storage medium having computer readable program instructions thereon for causing a processor to carry out aspects of the embodiments of the invention.

Computer readable storage media, which is inherently non-transitory, may include volatile and non-volatile, and removable and non-removable tangible media implemented in any method or technology for storage of information, such as computer-readable instructions, data structures, program modules, or other data. Computer readable storage media may further include RAM, ROM, erasable programmable read-only memory (EPROM), electrically erasable programmable read-only memory (EEPROM), flash memory or other solid state memory technology, portable compact disc read-only memory (CD-ROM), or other optical storage, magnetic cassettes, magnetic tape, magnetic disk storage or other magnetic storage devices, or any other medium that can be used to store the desired information and which can be read by a computer. A computer readable storage medium should not be construed as transitory signals per se (e.g., radio waves or other propagating electromagnetic waves, electromagnetic waves propagating through a transmission media such as a waveguide, or electrical signals transmitted through a wire). Computer readable program instructions may be downloaded to a computer, another type of programmable data processing apparatus, or another device from a computer readable storage medium or to an external computer or external storage device via a network.

Computer readable program instructions stored in a computer readable medium may be used to direct a computer, other types of programmable data processing apparatus, or other devices to function in a particular manner, such that the instructions stored in the computer readable medium produce an article of manufacture including instructions that implement the functions, acts, and/or operations specified in the flowcharts, sequence diagrams, and/or block diagrams. The computer program instructions may be provided to one or more processors of a general purpose computer, a special purpose computer, or other programmable data processing apparatus to produce a machine, such that the instructions, which execute via the one or more processors, cause a series of computations to be performed to implement the functions, acts, and/or operations specified in the flowcharts, sequence diagrams, and/or block diagrams.

In certain alternative embodiments, the functions, acts, and/or operations specified in the flowcharts, sequence diagrams, and/or block diagrams may be re-ordered, processed serially, and/or processed concurrently consistent with embodiments of the invention. Moreover, any of the flowcharts, sequence diagrams, and/or block diagrams may include more or fewer blocks than those illustrated consistent with embodiments of the invention.

The terminology used herein is for the purpose of describing particular embodiments only and is not intended to be limiting of the embodiments of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof. Furthermore, to the extent that the terms “includes”, “having”, “has”, “with”, “comprised of”, or variants thereof are used in either the detailed description or the claims, such terms are intended to be inclusive in a manner similar to the term “comprising”.

While all of the invention has been illustrated by a description of various embodiments and while these embodiments have been described in considerable detail, it is not the intention of the Applicant to restrict or in any way limit the scope of the appended claims to such detail. Additional advantages and modifications will readily appear to those skilled in the art. The invention in its broader aspects is therefore not limited to the specific details, representative apparatus and method, and illustrative examples shown and described. Accordingly, departures may be made from such details without departing from the spirit or scope of the Applicant's general inventive concept.

What is claimed is:

1. An online transaction processing system comprising:
at least one mass storage memory device storing a first database that includes a plurality of first records, each of the first records including first data that relates to one of a plurality of issuer systems;
one or more processors; and
a memory coupled to the one or more processors, the memory including instructions that upon execution by the one or more processors cause the online transaction processing system to:
in response to receiving payment data that is associated with a first online transaction involving a merchant and that relates to a particular one of the issuer systems, retrieve, from the first database, the first data that relates to the particular issuer system;
select an optimal acquirer system for the first online transaction from a plurality of acquirer systems that each have a relationship with the merchant based on the retrieved first data; and
transmit a request for a payment-related operation for the first online transaction to the optimal acquirer system.

2. The online transaction processing system of claim 1, wherein the instructions cause the online transaction processing system to select the optimal acquirer system from the acquirer systems each having the relationship with the merchant based on the retrieved first data by causing the online transaction processing system to:
determine a transactional cost associated with each of the acquirer systems based on the retrieved first data;
determine which of the acquirer systems is associated with a lowest transactional cost; and
select the acquirer system associated with the lowest transactional cost as the optimal acquirer system.

3. The online transaction processing system of claim 2, wherein the at least one mass storage memory device further comprises a second database that includes a plurality of second records, each of the second records including second data that identifies one or more fees associated with one of the acquirer systems, and the instructions cause the online transaction processing system to determine the transactional cost associated with each of the acquirer systems based on the second data of each of the second records in the second database.

4. The online transaction processing system of claim 3, wherein the one or more fees associated with one of the acquirer systems includes an interchange fee associated with the one acquirer system and a service fee associated with the one acquirer system.

5. The online transaction processing system of claim 1, wherein the first data that relates to one of the issuer systems identifies a country of the one issuer system and a home currency of the one issuer system.

6. The online transaction processing system of claim 5, wherein the optimal acquirer system includes a home currency that is the same as the home currency of the particular issuer system, the payment data indicates a payment amount for the first online transaction and a payment currency for the first online transaction, the payment currency being different from the home currency of the optimal acquirer system, and the instructions upon execution further cause the online transaction processing system to:
convert the payment amount from the payment currency to the home currency of the optimal acquirer system, wherein the request for the payment-related operation for the first online transaction includes the converted payment amount.

7. The online transaction processing system of claim 1, wherein the particular issuer system and the optimal acquirer system are both in a first geographic region.

8. The online transaction processing system of claim 7, wherein the first online transaction is initiated by a customer in a second geographic region that differs from the first geographic region.

9. The online transaction processing system of claim 1, wherein the at least one mass storage memory device further comprises a third database relating to a machine learning mechanism, and the instructions upon execution further cause the online transaction processing system to:
update the third database based on the payment data associated with the first online transaction and the optimal acquirer system selected based on the received first data.

10. The online transaction processing system of claim 9, wherein the third database includes a plurality of third records, each of the third records including third data that relates to previous payment data received at the one or more processors and that is linked to a previous optimal acquirer system selected by the one or more processors based on the previous payment data, and the instructions upon execution further cause the online transaction processing system to:
in response to receiving additional payment data that is associated with a second online transaction, query the machine learning database for third data that matches the additional payment data; and
select the previous optimal acquirer that is linked to the matching third data as the optimal acquirer for the second online transaction.

11. A method comprising:
receiving, at one or more processors of an online transaction processing system, payment data that is associated with a first online transaction involving a merchant and that relates to a particular one of a plurality of issuer systems;
querying, by the one or more processors, a first database based on the payment data, wherein the first database is stored on at least one mass storage memory device and includes a plurality of first records, each of the first records including first data that relates to one of the issuer systems;
receiving, at the one or more processors and from the first database, the first data that relates to the particular issuer system;
selecting, by the one or more processors, an optimal acquirer system for the first online transaction from a plurality of acquirer systems that each have a relationship with the merchant based on the received first data; and
transmitting, by the one or more processors, a request for a payment-related operation for the first online transaction to the optimal acquirer system.

12. The method of claim 11, wherein selecting the optimal acquirer system from the acquirer systems that each have the relationship with the merchant based on the received first data comprises:
determining a transactional cost associated with each of the acquirer systems based on the received first data;
determining which of the acquirer systems is associated with a lowest transactional cost; and
selecting the acquirer system associated with the lowest transactional cost as the optimal acquirer system.

13. The method of claim 12, wherein the at least one mass storage memory device further comprises a second database that includes a plurality of second records, each of the second records including second data that identifies one or more fees associated with one of the acquirer systems, and the transactional cost associated with each of the acquirer systems is determined based on the second data of each of the second records in the second database.

14. The method of claim 13, wherein the one or more fees associated with one of the acquirer systems includes an interchange fee associated with the one acquirer system and a service fee associated with the one acquirer system.

15. The method of claim 11, wherein the first data that relates to one of the issuer systems identifies a country of the one issuer system and a home currency of the one issuer system.

16. The method of claim 15, wherein the optimal acquirer system includes a home currency that is the same as the home currency of the particular issuer system, the payment data indicates a payment amount for the first online transaction and a payment currency for the first online transaction, the payment currency being different from the home currency of the optimal acquirer system, and further comprising:
converting the payment amount from the payment currency to the home currency of the optimal acquirer system, wherein the request for the payment-related operation for the first online transaction includes the converted payment amount.

17. The method of claim 11, wherein the particular issuer system and the optimal acquirer system are both in a first geographic region.

18. The method of claim 17, wherein the first online transaction is initiated by a customer in a second geographic region that differs from the first geographic region.

19. The method of claim 11, wherein the at least one mass storage memory device further comprises a third database that relates to a machine learning mechanism, the third database including a plurality of third records, each of the third records including third data that relates to previous payment data received at the one or more processors and that is linked to a previous optimal acquirer system selected by the one or more processors based on the previous payment data, and further comprising:
updating the third database based on the payment data associated with the first online transaction and the optimal acquirer system selected based on the received first data;
receiving additional payment data that is associated with a second online transaction;
in response to receiving the additional payment data that is associated with the second online transaction, querying the machine learning database for third data that matches the additional payment data; and
selecting the previous optimal acquirer that is linked to the matching third data as the optimal acquirer for the second online transaction.

20. A computer program product comprising:
a non-transitory computer readable medium; and
instructions stored on the computer readable medium, wherein the instructions upon execution by one or more processors cause the one or more processors to:
receive payment data that is associated with an online transaction involving a merchant and that relates to a particular one of a plurality of issuer systems;
query a first database based on the payment data, wherein the first database is stored on at least one mass storage memory device and includes a plurality of first records, each of the first records including first data that relates to one of the issuer systems;
receive, from the first database, the first data that relates to the particular issuer system;
select an optimal acquirer system for the online transaction from a plurality of acquirer systems that each have a relationship with the merchant based on the received first data; and
transmit a request for a payment-related operation for the online transaction to the optimal acquirer system.
